(19) United States
(12) Patent Application Publication
(10) Pub. No.: US 2006/0005224 A1
(43) Pub. Date: Jan. 5, 2006

(54) Technique for cooperative distribution of video content

(76) Inventors: John Dunning, Nepean (CA); Sheng Sun, Kanata (CA); Kawai Gary Chan, Nepean (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/880,199

(22) Filed: Jun. 30, 2004

(51) Int. Cl. H04N 7/173; H04N 7/16

(52) U.S. Cl. 725/115; 725/116; 725/145; 725/146

(57) ABSTRACT

A technique for cooperative distribution of video content is disclosed. In one particular exemplary embodiment, the technique may be realized as a method for cooperative distribution of video content. The method may comprise providing a plurality of content servers at a plurality of network nodes, wherein each of the plurality of content servers holds a portion of a complete set of video content offered to a plurality of users. The method may also comprise receiving, at a first content server, a request for video content. The method may further comprise retrieving, from at least one second content server, the requested video content if the requested video content is not available at the first content server. The method may additionally comprise forwarding the requested video content to one or more users.

### FIELD OF THE DISCLOSURE

The present disclosure relates generally to computer and communications networks and, more particularly, to a technique for cooperative distribution of video content.

### BACKGROUND OF THE DISCLOSURE

Video-on-demand (VOD) is a type of interactive television service that has become increasingly popular in recent years. In order to provide the viewers with a truly interactive experience, it is critical to distribute video content in an efficient way so that any VOD service request may be fulfilled with minimal delay.

VOD content can be distributed in either a centralized or a decentralized approach. With the centralized approach, a complete set of video content offered to VOD users may be stored in one central server and all users have to communicate with the central server to retrieve VOD content. With the decentralized approach, a number of distributed local servers may be deployed each duplicating the complete set of video content, and a user's request is usually fulfilled by the nearest local server.

There are problems with both approaches. For example, the centralized approach relies heavily on the bandwidth and traffic conditions of network connections between the central server and individual VOD users. Though a dedicated transport network could guarantee content delivery, such a network is usually too expensive to build or maintain. In contrast, the traditional decentralized approach minimizes transport by placing the video content close to the VOD users. However, this is done at the expense of higher storage and operation costs. Since each distributed VOD server stores a duplicate of the complete set of video content, the total amount of resources dedicated to storage can be considerable. The overall storage cost can increase very quickly with the number of distributed servers or the size of the video content collection. In addition, a significant amount of effort is necessary to manage and update the duplicate content.

In view of the foregoing, it would be desirable to provide a solution for distribution of video content which overcomes the above-described inadequacies and shortcomings.

### SUMMARY OF THE DISCLOSURE

A technique for cooperative distribution of video content is disclosed. In one particular exemplary embodiment, the technique may be realized as a method for cooperative distribution of video content. The method may comprise providing a plurality of content servers at a plurality of network nodes, wherein each of the plurality of content servers holds a portion of a complete set of video content offered to a plurality of users. The method may also comprise receiving, at a first content server, a request for video content. The method may further comprise retrieving, from at least one second content server, the requested video content if the requested video content is not available at the first content server. The method may additionally comprise forwarding the requested video content to one or more users.

In accordance with other aspects of this particular exemplary embodiment, at least one of the plurality of content servers may be a video-on-demand (VOD) server.

In accordance with further aspects of this particular exemplary embodiment, at least one of the plurality of content servers may be a broadcast server.

In accordance with additional aspects of this particular exemplary embodiment, the plurality of content servers may, together, hold the complete set of video content offered to the plurality of users.

In accordance with a further aspect of this particular exemplary embodiment, the plurality of content servers may share at least one portion of the complete set of video content over one or more symmetrical network connections.

In accordance with a yet further aspect of this particular exemplary embodiment, at least one of the plurality of network nodes may be a first point of aggregation for one or more of the plurality of users.

In accordance with a still further aspect of this particular exemplary embodiment, at least one of the plurality of network nodes is a digital subscriber line access multiplexer (DSLAM) site.

In accordance with another aspect of this particular exemplary embodiment, the method may further comprise caching the requested video content in the first content server.

In accordance with yet another aspect of this particular exemplary embodiment, at least part of the complete set of video content may be provided by a central source.

In accordance with still another aspect of this particular exemplary embodiment, the plurality of content servers may communicate with the plurality of users based on a plurality of asymmetrical network connections.

In another particular exemplary embodiment, the technique may be realized by at least one signal embodied in at least one carrier wave for transmitting a computer program of instructions configured to be readable by at least one processor for instructing the at least one processor to execute a computer process for performing the method as recited above.

In yet another particular exemplary embodiment, the technique may be realized by at least one processor readable carrier for storing a computer program of instructions configured to be readable by at least one processor for instructing the at least one processor to execute a computer process for performing the method as recited above.

In still another particular exemplary embodiment, the technique may be realized by a method for cooperative distribution of video content. The method may comprise storing, at a first user site, a portion of a complete set of video content offered to a plurality of users. The method may also comprise receiving, from a second user site, a request for video content. The method may further comprise retrieving, from at least one third user site or content server, the requested video content if the requested video content is not available at the first user site. The method may additionally comprise forwarding the requested video content to the second user site.

In a further particular exemplary embodiment, the technique may be realized by a system for cooperative distribution of video content, the system comprising a plurality of content servers located at a plurality of network nodes, wherein each of the plurality of content servers holds a portion of a complete set of video content offered to a plurality of users, such that a first content server can fulfill a request for video content by retrieving, from at least one second content server, the requested video content if the requested video content is not available at the first content server.

In accordance with other aspects of this particular exemplary embodiment, at least one of the plurality of content servers may be a video-on-demand (VOD) server.

In accordance with further aspects of this particular exemplary embodiment, at least one of the plurality of content servers may be a broadcast server.

In accordance with additional aspects of this particular exemplary embodiment, the plurality of content servers may, together, hold the complete set of video content offered to the plurality of users.

In accordance with a further aspect of this particular exemplary embodiment, at least one of the plurality of network nodes may be a first point of aggregation for one or more of the plurality of users.

In accordance with a yet further aspect of this particular exemplary embodiment, at least one of the plurality of network nodes may be a digital subscriber line access multiplexer (DSLAM) site.

In accordance with a still further aspect of this particular exemplary embodiment, the system may further comprise means for caching the requested video content in the first content server.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is a flow chart illustrating an exemplary method for cooperative distribution of video content in accordance with an embodiment of the present disclosure.

FIG. 2 is a block diagram illustrating an exemplary system for cooperative distribution of video content in accordance with an embodiment of the present disclosure.

FIG. 3 is a block diagram illustrating another exemplary system for cooperative distribution of video content in accordance with an embodiment of the present disclosure.

FIG. 4 is a block diagram illustrating yet another exemplary system for cooperative distribution of video content in accordance with an embodiment of the present disclosure.

### DETAILED DESCRIPTION OF EXEMPLARY EMBODIMENT(S)

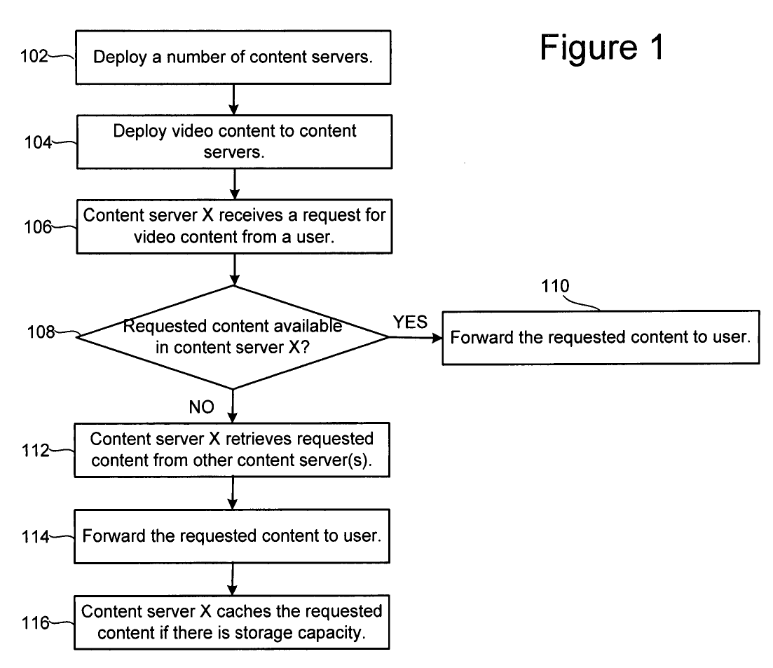

Referring to FIG. 1, there is shown a flow chart illustrating an exemplary method for cooperative distribution of video content in accordance with an embodiment of the present disclosure.

In step 102, a number of content servers may be deployed. A content server may comprise one or more processors, one or more storage devices and at least one network interface. Each content server may be placed at a network node that serves a number of users (e.g., VOD subscribers). From the users' perspective, the network node may be a first point of aggregation. According to one embodiment of the disclosure, a content server may be placed at a digital subscriber line access multiplexer (DSLAM) site (e.g., a telephone company central office). All the content servers may be linked via high-speed connections to form a network of servers. These networked content servers are also called “peering content servers” or “peering servers.”

In step 104, video content may be deployed to the content servers. The video content may be VOD content from a central source or may be obtained by each content server independent of the central source. Each content server may hold only a portion of the complete set of video content offered to the users. The network of content servers may together supply the complete set of video content. For example, in a VOD system with 8 peering content servers, each peering content server may hold ⅛ of the complete set of video content.

In step 106, a local content server may receive a request for video content from a user. For illustration purposes, this local content server is hereinafter referred to as “content server X” or “server X.” The user may be from a geographic area served by the content server X. The request for video content may be a VOD service request seeking a specific piece of video content.

In step 108, the content server X may determine whether the requested video content is available locally (i.e., in server X). If it is available in the content server X, the requested content may be forwarded (e.g., streamed) to the user immediately in step 110.

If the requested video content is not available locally, the content server X may, in step 112, retrieve the content from one or more other content servers. Each content server may have maintained a list of video content that is stored in the other content servers. Such list may be updated periodically or upon distribution of new content. Therefore, whenever a piece of video content is not found locally, the content server X may quickly determine which other content servers hold this piece of video content. Once the requested content is retrieved, the content server X may forward it to the user in step 114.

In step 116, the content server X may further cache the requested content locally if there is storage capacity to do so. In this way, if another local user requests this piece of video content, the cached copy may be quickly served without having to retrieve it for a second time. Depending on the connection between the content server X and the content server(s) hosting the requested content, caching of the video content may be done at different data rates. Accordingly, content caching at the content server X may be in real-time or non-real-time with respect to the streaming of the requested content to the user. For example, if the requested content can be cached at a rate at least as fast as the video streaming rate, content caching may be done in real-time, that is, at the same time as the video streaming. In the real-time caching scenario, the steps 112, 114 and 116 are effectively collapsed into one step. If, however, the requested content is cached at a slower rate than the video streaming rate, then a significant portion of the requested content may have to be cached first before it is served to the user. For example, if caching is at half the video streaming rate, it may be necessary to cache ¾ of the requested content before starting the playback. In this non-real-time caching scenario, step 116 may occur prior to step 114, or there may be some overlap between these two steps.

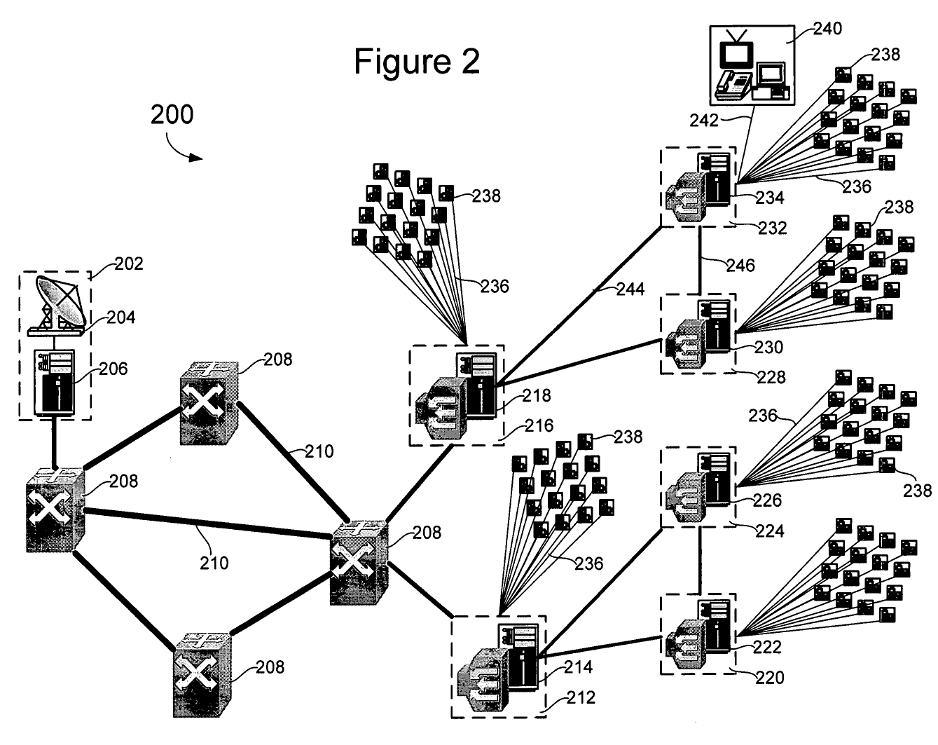

Referring now to FIG. 2, there is shown a block diagram illustrating an exemplary system 200 for cooperative distribution of video content in accordance with an embodiment of the present disclosure. As shown, the exemplary system 200 comprises a central content source 202, network elements 208, and peering content servers (e.g., 214, 218, 222, 226, 230 and 234). The central content source 202 may comprise a satellite receiver station 204 and a central content server 206. The central content source 202 and the network elements 208 may be connected by high-speed network connections 210. The network elements 208 may be further connected with the network nodes (e.g., 212 and 216), where the peering content servers (e.g., 214 and 218) are located. Each peering content server may hold a portion of a complete set of video content offered to users of the system 200. Each peering content server may serve a number of users 238 via local connections 236. All the peering content servers may be interconnected by network connections (e.g., 244 and 246).

In operation, the central content source 202 may deploy video content, via the core network formed by the network elements 208 and connections 210, to the various peering content servers. Unlike the traditional decentralized approach, none of the peering content servers has to hold the complete set of video content. They each only hold a portion but cooperate with one another to make the complete set available to the users. For example, a particular user 240 may send in a request for video content to the peering content server 234. If the requested content is available locally, the peering content server 234 may serve it to the user 240 immediately. If the requested content is not available locally, the peering content server 234 may obtain it from peering content server 218, for example, and then serve it to the user 240. The peering content server 234 may further cache the requested content if it has storage capacity to do so.

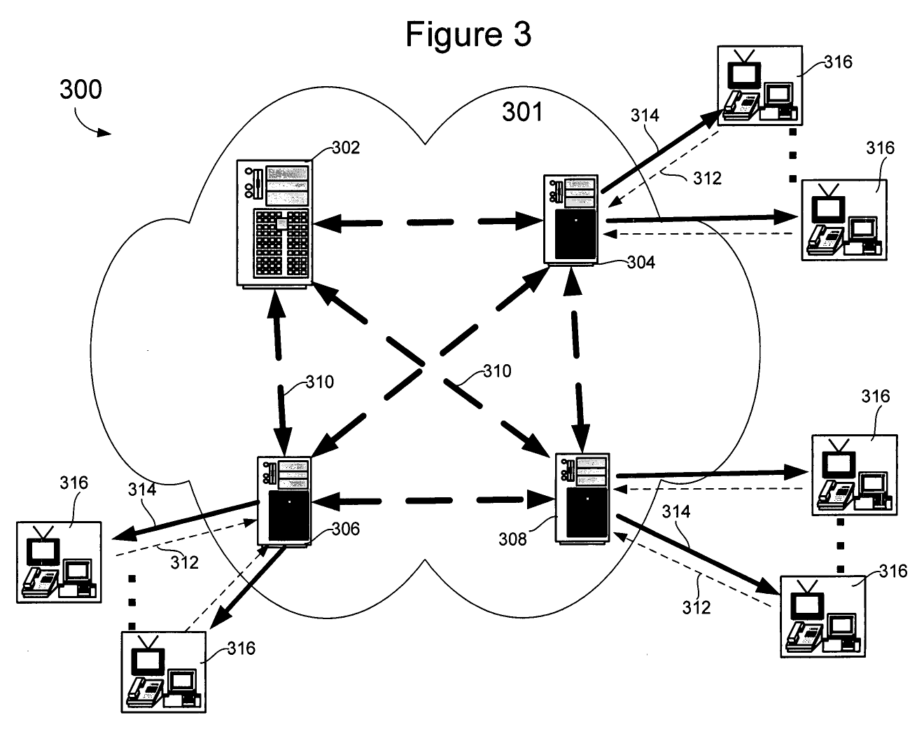

Referring to FIG. 3, there is shown a block diagram illustrating another exemplary system 300 for cooperative distribution of video content in accordance with an embodiment of the present disclosure. The exemplary system 300 comprises a simplified configuration of one central content server 302 and three peering content servers 304, 306 and 308. All these content servers may be connected with one another by a meshed symmetrical network 301 having connections 310 that may have symmetrical bandwidth. The peering content servers 304, 306 and 308 may each serve a number of users 316. The connection between a peering content server and a user 316 may have asymmetrical bandwidth, where a downstream link 314 may be substantially faster than an upstream link 312.

According to one embodiment, each of the peering content servers 304, 306 and 308 may contain one third of the complete set of video content offered to the users 316. When a peering content server receives a request for video content, the chance is then one in three for the requested content to be found locally in the peering content server. Statistically, only two thirds of the total requests will then require retrieval of video content from other servers. Therefore, compared with a centralized system with one central content server only, the network traffic in system 300 may be two thirds of that in the centralized system. Since only one third of the total content is deployed to each peering content server, the network path between the central content server 302 and a peering content server may be only one third of a full feed. Despite the not-to-scale drawing in FIG. 3, the peering content servers 304, 306 and 308 are typically located closer to one another than they are to the central content server 302.

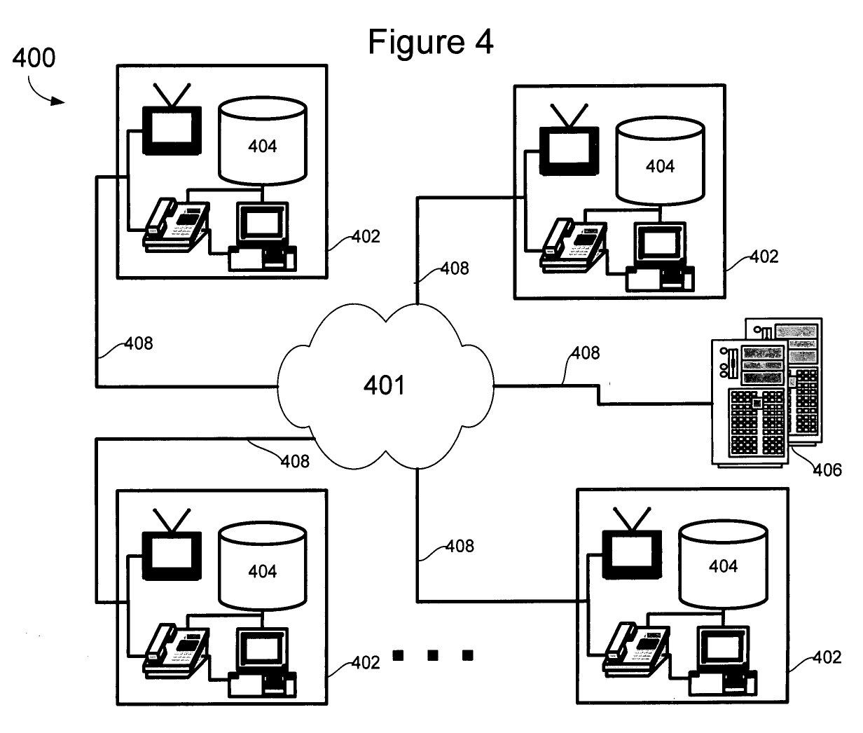

FIG. 4 is a block diagram illustrating yet another exemplary system 400 for cooperative distribution of video content in accordance with an embodiment of the present disclosure. According to an embodiment of the present disclosure, the technique for cooperative distribution of video content may be extended to user sites and FIG. 4 depicts one such example.

The exemplary system 400 may comprise a number of user sites 402. A user site 402 may be a VOD subscriber's home, for example. Each user site may comprise a storage or recording device 404, such as a personal video recorder (PVR) or digital video recorder (DVR). The user sites 402 may be connected together via network links 408 and a network 401. The network 401 may be further connected to one or more content servers 406 (e.g., a central content server and/or peering content servers). In a first mode of operation, the user sites 402 may supplement the cooperative distribution of video content from the content server(s) 406 by caching certain video content, such as those on high demand, in local storage or recording device 404. Then, the user sites 402 may cooperate with each other to provide the cached content upon request. In a second mode of operation, the complete set of video content may be divided up and distributed to the user sites 402. Then the user sites 402 may cooperate to provide each other video content upon request. In this mode, there may be no peering content servers, but the user sites 402 may function as peering content servers on the end user level. Alternatively, the first and the second modes of operation may be combined, where the complete set of video content can be distributed among one or more peering content servers and the user sites 402.

At this point it should be noted that the technique for cooperative distribution of video content in accordance with the present disclosure as described above typically involves the processing of input data and the generation of output data to some extent. This input data processing and output data generation may be implemented in hardware or software. For example, specific electronic components may be employed in a computer and/or communications network or similar or related circuitry for implementing the functions associated with cooperative distribution of video content in accordance with the present disclosure as described above. Alternatively, one or more processors operating in accordance with stored instructions may implement the functions associated with cooperative distribution of video content in accordance with the present disclosure as described above. If such is the case, it is within the scope of the present disclosure that such instructions may be stored on one or more processor readable carriers (e.g., a magnetic disk), or transmitted to one or more processors via one or more signals.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the following appended claims. Further, although the present disclosure has been described herein in the context of a particular implementation in a particular environment for a particular purpose, those of ordinary skill in the art will recognize that its usefulness is not limited thereto and that the present disclosure can be beneficially implemented in any number of environments for any number of purposes. Accordingly, the claims set forth below should be construed in view of the full breadth and spirit of the present disclosure as described herein.

1. A method for cooperative distribution of video content, the method comprising:
providing a plurality of content servers at a plurality of network nodes, wherein each of the plurality of content servers holds a portion of a complete set of video content offered to a plurality of users;
receiving, at a first content server, a request for video content;
retrieving, from at least one second content server, the requested video content if the requested video content is not available at the first content server; and
forwarding the requested video content to one or more users.

2. The method according to claim 1, wherein at least one of the plurality of content servers is a video-on-demand (VOD) server.

3. The method according to claim 1, wherein at least one of the plurality of content servers is a broadcast server.

4. The method according to claim 1, wherein the plurality of content servers, together, hold the complete set of video content offered to the plurality of users.

5. The method according to claim 1, wherein the plurality of content servers share at least one portion of the complete set of video content over one or more symmetrical network connections.

6. The method according to claim 1, wherein at least one of the plurality of network nodes is a first point of aggregation for one or more of the plurality of users.

7. The method according to claim 1, wherein at least one of the plurality of network nodes is a digital subscriber line access multiplexer (DSLAM) site.

8. The method according to claim 1 further comprising caching the requested video content in the first content server.

9. The method according to claim 1, wherein at least part of the complete set of video content is provided by a central source.

10. The method according to claim 1, wherein the plurality of content servers communicate with the plurality of users based on a plurality of asymmetrical network connections.

11. At least one signal embodied in at least one carrier wave for transmitting a computer program of instructions configured to be readable by at least one processor for instructing the at least one processor to execute a computer process for performing the method as recited in claim 1.

12. At least one processor readable carrier for storing a computer program of instructions configured to be readable by at least one processor for instructing the at least one processor to execute a computer process for performing the method as recited in claim 1.

13. A method for cooperative distribution of video content, the method comprising:
storing, at a first user site, a portion of a complete set of video content offered to a plurality of users;
receiving, from a second user site, a request for video content;
retrieving, from at least one third user site or content server, the requested video content if the requested video content is not available at the first user site; and
forwarding the requested video content to the second user site.

14. A system for cooperative distribution of video content, the system comprising a plurality of content servers located at a plurality of network nodes, wherein each of the plurality of content servers holds a portion of a complete set of video content offered to a plurality of users, such that a first content server can fulfill a request for video content by retrieving, from at least one second content server, the requested video content if the requested video content is not available at the first content server.

15. The system according to claim 14, wherein at least one of the plurality of content servers is a video-on-demand (VOD) server.

16. The system according to claim 14, wherein at least one of the plurality of content servers is a broadcast server.

17. The system according to claim 14, wherein the plurality of content servers, together, hold the complete set of video content offered to the plurality of users.

18. The system according to claim 14, wherein at least one of the plurality of network nodes is a first point of aggregation for one or more of the plurality of users.

19. The system according to claim 14, wherein at least one of the plurality of network nodes is a digital subscriber line access multiplexer (DSLAM) site.

20. The system according to claim 14 further comprising means for caching the requested video content in the first content server.
